(19) United States
(12) Patent Application Publication
(10) Pub. No.: US 2024/0020536 A1
(43) Pub. Date: Jan. 18, 2024

(54) PROCESSOR ARCHITECTURE AND MODEL EXPLORATION SYSTEM FOR DEEP LEARNING

(71) Applicant: Groq, Inc., Mountain View, CA (US)

(72) Inventors: Andrew Chaang Ling, Toronto (CA); Jonathan Alexander Ross, Palo Alto, CA (US); Andrew Esper Bitar, Toronto (CA); Aidan Robert Byron Wood, Toronto (CA); Baorui Zhou, Toronto (CA)

(21) Appl. No.: 18/352,602

(22) Filed: Jul. 14, 2023

Related U.S. Application Data
(60) Provisional application No. 63/389,673, filed on Jul. 15, 2022.

(51) Int. Cl. G06N 3/08

(52) U.S. Cl. CPC G06N 3/08

(57) ABSTRACT

A processor architecture and model exploration system for deep learning is provided. A method of improving performance of a processor system and associated software includes selecting a set of performance parameter targets for a processor architecture having a set of functional units and an AI model. The method also includes evaluating performance of the processor architecture and the AI model and adjusting at least one of the functional units of the processor architecture to form a new processor architecture prior to iteratively evaluating the combination of the new processor architecture and the AI model. Further, the method includes repeating the evaluating step and the adjustment step until the performance evaluation of the processor architecture and AI model meets the set of performance parameter targets.

### RELATED APPLICATIONS

This application claims a benefit, and priority, under 35 U.S.C. § 119(e) to U.S. Provisional Patent Application Ser. No. 63/389,673, titled “Processor Architecture Modeling for Deep Learning,” filed on Jul. 15, 2022, which is hereby incorporated by reference in its entirety. This application is related to a commonly assigned application entitled PROCESSOR ARCHITECTURE MODELING FOR DEEP LEARNING to be filed on Jul. 14, 2023, which also claims priority to U.S. Provisional Patent Application Ser. No. 63/389,673 filed Jul. 15, 2022.

### TECHNICAL FIELD

The present disclosure generally relates to use of a system and process for adjusting processor architecture to improve performance of a selected Artificial Intelligence (AI) model.

### SPECIFICATION—DISCLAIMERS

In the following Background, Summary, and Detailed Description, paragraph headings are signifiers that do not limit the scope of an Embodiment of a Claimed Invention (ECIN). The citation or identification of any publication signifies neither relevance nor use as prior art. A writing enclosed in double quotes (“ ”) signifies an exact copy of a writing that has been expressed as a work of authorship. Signifiers, such as a word or a phrase enclosed in single quotes (‘ ’), signify a term that as of yet has not been defined and that has no meaning to be evaluated for, or has no meaning in that specific use (for example, when the quoted term ‘module’ is first used) until defined.

### BACKGROUND

Developing software for a new processor chip before the first silicon (physical chip) is available traditionally involves several techniques and methodologies. By way of example, expensive emulation or simulation platforms are commercially available that enable software programmers to create virtual representations of a hardware design of a new processor on the platform. These platforms allow software developers to run and test their code on a model of the chip, providing an environment similar to the target hardware. Emulation and simulation help identify software bugs, validate functionality, and optimize performance to at least a performant level before the physical chip is actually available.

While emulators and simulators are expensive to set up and configure, many software developers will set up a virtual prototype that requires a virtual representation or software model of the chip's behavior and architecture to be built. The model is typically executed on a host computer or a specialized platform. Software developers can write and test their code against the virtual prototype to gain insights into performance, functionality, and compatibility.

While virtual prototyping offers several advantages for software development before the availability of physical chips, there are also some challenges and limitations to consider. Specifically, virtual prototypes aim to simulate the behavior and functionality of the target chip, but they may not capture all nuances and intricacies of the actual hardware. The accuracy and realism of the virtual prototype may vary, and certain hardware-specific behaviors or timing effects might not be fully replicated or even exposed to the software programmers. This can lead to discrepancies between the virtual prototype and the final physical chip.

Further, virtual prototypes are typically executed on general-purpose computers or specialized platforms, which may not match the performance characteristics of the final chip. This performance gap can impact the execution speed and timing of software running on the virtual prototype, making it challenging to accurately assess real-time requirements or performance optimizations.

Virtual prototypes might not provide the same level of visibility into the internal workings of the chip compared to physical chips. Debugging complex issues, tracing specific signals, or analyzing low-level hardware interactions can be more challenging in a virtual prototyping environment and it requires close collaboration between hardware and software teams to ensure the accuracy of the virtual prototype. Coordinating the development efforts, synchronizing updates, and managing changes between hardware design and software development can be complex and time-consuming.

Creating an accurate and comprehensive model of the chip's behavior and architecture for virtual prototyping can be a challenging task. The level of detail and complexity required in the model can impact the development time, effort, and maintenance overhead.

Thus, while virtual prototypes can help identify software bugs and validate functionality, they might not fully capture all edge cases, system-level interactions, or unforeseen scenarios. Some issues may only arise when software is tested on the actual physical chip, necessitating additional validation steps or the design and manufacture of new silicon to correct latent bugs that were not originally identified in the initial design process.

In other instances, Field-Programmable Gate Array (FPGA) prototypes are configurable hardware devices that can be programmed to replicate the behavior of the target chip. Software developers can program the FPGA with a design that mimics the desired chip's functionality, allowing them to test and debug their software on a close approximation of the final hardware. However, designing a FPGA with a complex processor circuit is a significant design project that can take an extended period of time with high costs and typically only partially performant at the intended clock or capacity level of the target processor chip. However, the FPGA is not deterministic so power estimates at the compile stage are not very accurate and model dependent so once the FPGA chip is compiled, it must be combined with the model to determine power. Further, the FPGA compiler takes a long time, often over a day to compile a different chip design and then the compiled chip design and the compiled model must then be combined and run. The poor power estimation accuracy and time to compile a new combination of hardware and model render it a poor choice.

By leveraging these approaches, software developers can initiate software development, testing, and optimization activities in parallel with chip design and fabrication processes. This helps to reduce time-to-market, identify potential issues early, and ensure that software is ready to fully utilize the capabilities of the new chip once it becomes available but existing processes are time consuming, expensive and prone to having hidden flaws that will not be revealed until first silicon actually arrives.

Recently, AI models, written in programming languages such as PyTorch or TensorFlow, have gained significant attention and have found commercial applications in various fields, including natural language processing, computer vision, robotics, healthcare, finance, and more. Such models have revolutionized tasks that were traditionally difficult for computers to perform and have opened new possibilities for automation, intelligent decision-making, and problem-solving. AI models may include machine learning (ML) models that are trained on data to learn patterns and make predictions or decisions. They can be categorized into various types, including supervised learning models, unsupervised learning models, and reinforcement learning models. In other instances, AI models may be based on neural networks, particularly deep neural networks, which are a subset of machine learning models inspired by the structure and function of the human brain. These models consist of interconnected nodes (neurons) organized in layers and are capable of learning complex patterns and hierarchical representations. More recently, generative AI models, such as generative adversarial networks (GANs) or variational autoencoders (VAEs), that can generate new data samples based on the patterns and distributions learned during training, have been widely adopted for many applications. These AI models are often used in demanding applications that push existing computer and graphic processor chips to their operational limits causing the models to execute slowly or inefficiently. Thus, there is a need for an improved, more efficient, process for designing new processor chips especially if the target processor design will be used to execute complex demanding AI models.

### SUMMARY

In some embodiments this Summary, together with any Claims, is a brief set of signifiers for at least one embodiment of a claimed invention (EGIN), which can be a discovery, see 35 USC 100(a); and see 35 USC 100(j), for use in commerce for which the Specification and Drawings satisfy 35 USC 112.

Specifically, a system and method for iteratively improving performance by optimizing or developing an AI model together with a processor chip that is organized to allow for high performance execution of the model. Advantageously, no simulator is required to achieve the desired high performance or to finalize development, of either the processor architecture or the AI model. The system comprises a hardware composer, a software composer and a performance calculator coupled to a compiler that mode's performance with cycle by cycle accuracy.

In one ECIN, the hardware composer passes a processor architecture to a compiler to determine whether a machine learning; AI model will meet selected performance constraints in an automated flow.

In one ECIN, a methodology to create the processor architecture as a companion to the neural network model. More specifically, a methodology to model a plurality of processor architectures for compilation flows enables architectural exploration and provides a way to model the spatial architecture of a TSP processor. The compilation can be implemented for any arbitrary spatial TSP architecture using either ASIC or FPGA devices. The processor architecture can be uniquely defined for a selected ML car AI model without having to update the software compiler.

The compiler-driven architecture exploration enables performance advantages over systems that rely on a single CPU or GPU architecture.

This Summary does not completely signify any ECIN. While this Summary can signify at least one essential element of an ECIN enabled by the Specification and Figures, the Summary does not signify any limitation in the scope of any EON.

### BRIEF DESCRIPTION OF THE DRAWINGS

FIG. 1 illustrates a method for iteratively selecting and optimizing a processor and/or an AI model in accordance with an embodiment for the purposes of the present technology.

FIG. 2 depicts a block diagram of a system for implementing the method of FIG. 1 in accordance with an embodiment for the purposes of the present technology.

FIG. 3 depicts a hardware architecture library in accordance with an embodiment for the purposes of the present technology.

FIG. 4 depicts a mechanism for transferring the processor architecture to a compiler in accordance with an embodiment for the purposes of the present technology.

FIGS. 5 and 6 depict various processor architecture in accordance with an embodiment for the purposes of the present technology.

FIG. 7 illustrates the components of a compiler in accordance with an embodiment for the purposes of the present technology.

FIG. 8 illustrates a prior art computer system.

In the Figures, reference signs can be omitted as is consistent with accepted engineering practice; however, a skilled person will understand that the illustrated components are understood in the context of the Figures as a whole, of the accompanying writings about such Figures, and of the embodiments of the claimed inventions.

### DETAILED DESCRIPTION OF THE DRAWINGS

This disclosure provides a methodology to model and improve processor architectures and performance for selected compilation flows and to enable architecture exploration. The following described methodology can model a spatial architecture, in a generalized way, such that compilation can be implemented for various processor spatial architectures. In some embodiments, changing architecture does not require a rewrite or update to the compiler.

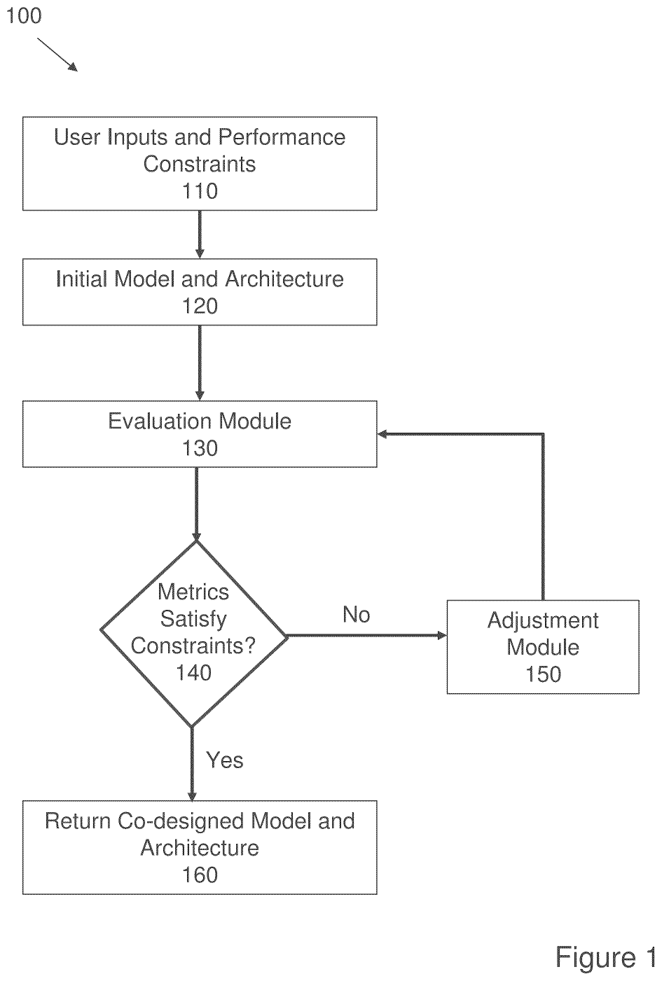

FIG. 1 illustrates a computing system and method 100 supporting creation of an AI model and an architecture for a processor for executing a compiled version of the AI model. In one embodiment, a user provides inputs, architecture, and performance targets (module 110). At least one initial model is then selected (module 120) and can be optionally trained with one or more dataset. The selected model is evaluated (module 130) using associated software that can include a compiler and a performance calculator. Once the model is evaluated, a determination can be made as to whether performance metrics are satisfied (module 140) when the model is executed by the processor. This can include a determination of whether or not speed, power, throughput, silicon area, which directly translate into costs, or other performance metrics of the model being tested on a particular processor architecture meets the performance targets. If the model operation on a particular processor architecture is not satisfactory, an adjustment module 150 model can make user or machine based changes to the processor architecture or the model before retesting by the training and evaluation module 130. More specifically, the changes or updates by the adjustment module 150 can also include, for example, addition of more processing layers to the model, removal of a processing layer, addition, subtraction, or modification of the processor. This process can be iterated by training the new model/architecture and evaluating the new model/architecture until the required performance is met. If all performance metrics are satisfied the performance improved model and architecture is returned (module 160) as satisfactory.

As used herein, a processor and a processor architecture are related concepts but refer to different aspects of a processor system. Specifically, a processor, such as a CPU or a GPU, performs calculations under the control of program instructions. The processor performs tasks such as arithmetic operations, logical operations, and data movement. ‘Processor architecture’, also referred to as computer architecture, encompasses the design and organization of a processor. It defines the structure, behavior, and functionality of the processor, including its instruction set, registers, memory organization, data paths, control units, and other internal components. Processor architecture provides the foundation that determines how the processor executes instructions, handles data, and interacts with other system components. Processor architecture influences factors like instruction set design, performance characteristics, power consumption, and compatibility with software. Multiple processors can share the same architecture, allowing for compatibility across different processor implementations.

In some embodiments, user inputs to module 110 can include various types or amounts of input data (including labeled and unlabeled data for training machine learning systems), available models for machine learning, deep learning, or AI processing systems, and model accuracy parameters. In some embodiments, performance targets or metrics such as processing time, maximum number of available processors, required power, or thermal targets can be input. In some embodiments, processor architecture, processor type, spatial layout of processor modules, and multiple processor connectivity can be inputs.

In some embodiments, processor architectures can include deterministic processor architectures or non-deterministic processor architectures. A deterministic processor architecture acts so that given an initial state or condition and a processing task, the same results will be produced with the same speed or performance each time the task is executed. There is no randomness or variation in the ways that data is delivered or processed into an output. In contrast, in a non-deterministic processor architecture there is some randomness, often due to differences in process scheduling or the time to execute the instructions for various tasks each time the task is executed.

In some embodiment, processor architectures, whether deterministic or non-deterministic, can include reduced instruction set computers (RISC) processors, complex instruction set computers (CISC) processors, application specific integrated circuits (ASIC) or field programmable gate-array (FPGA) configured to execute a certain instruction set architecture, as well as tensor streaming processors (TSP).

Each functional slice of the deterministic processor operates on a set of data lanes in a Single Instruction Multiple Data (SIMD) manner.

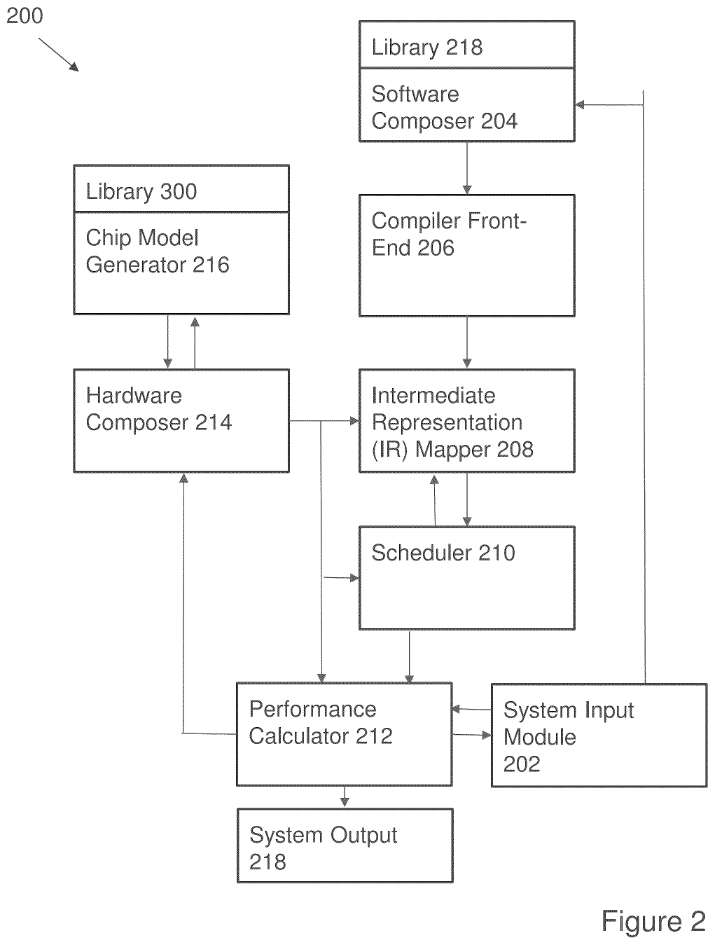

FIG. 2 depicts a system block diagram of a system 200 for implementing the method of FIG. 1. System 200 obtains inputs from system input module 202. Inputs are a selected machine learning model which may be selected from, by way of example, any of the various common types of machine learning models including supervised learning models, unsupervised learning models, semi-supervised learning models, reinforcement learning models, deep learning models and ensemble models. Please note that this is a high-level list, and each category encompasses various algorithms, techniques, and specific models. including but not limited to GPT variants (e.g., Generative Pre-trained Transformer (GPT), GPT-2, GPT-3, GPT-4, DistillGPT2, OpenAI-GPT, or EleutherAI/gpt-j-6b) as well as models such as Large Language Model Meta AI (LLaMA), BERT, XLNet, or RoBERTa.

Inputs also include performance constraints that can include any performance constraint in terms of response time, latency or throughput, power reliability, cost, available process technology, and supported numerics.

When system input module 202 provides the model selection and performance constraints, a software composer 204 either selects a model from a library of models or generates the requested model as is described in more detail below. The selected (or generated) model is then passed by software composer 204 to a compiler front-end 206. The function of compiler front-end 206 is to convert the model, which is typically written in a high level language such as PyTorch, TensorFlow or Keras, to an intermediate representation that is device agnostic. Compiler front-end 206 may comprise a version of one or both of the ONNX or MLIR software packages, both of which are widely supported by the open source community. The intermediate representation is passed by compiler front-end 206 to a mapping module, mapper 208, that is a software module tasked with creating a lower level representation of instructions of the model that is processor specific. This means that the individual instructions are mapped or associated with specific processor functional units such as memory or a multiplier and the like. The mapped low level IR representation is then transferred to scheduler 210 where each instruction is scheduled for execution on the processor. The processor that mapper 208 maps to is selected by hardware composer 214 as described below.

In one ECIN, software composer 204 provides a selected model from library 218 that is pre-configured in the processor specific low level IR representation such that the front-end compiler process may be by-passed. In this instance, the selected model is immediately passed through to mapper 208 thereby accelerating the time to obtain the performance results.

Scheduler 210 is a software module that tracks operand processing, including calculating how long it will take for an operand to arrive at a specific functional unit and when the instruction that operates on the operand should be issued. In the event that the scheduler 210 does not have sufficient processor resources to implement execution of the instructions for the selected model, the scheduler may issue a request to the mapper to remap the processor resources and provide a second modified map of instructions to functional units. The output of scheduler 210 is then passed to performance calculator 212 which is a software module that calculates the time, power and other metrics that it will take to execute each instruction of the selected model. Performance calculator 212 also compares the calculated results to the input constraints.

If the calculated results meet or exceed the input constraints, the model is delivered as compiled code for execution on the selected processor. The compiled code may be subsequently executed by a processor located, by way of example, in a data center or locally if the code is to be executed by a mobile computing device such as a cell phone or an autonomous vehicle.

If, however, performance calculator 212 calculates that one or more of the input constraints were not met or exceeded, performance calculator, in one embodiment, generates a request for hardware composer 214 to select or to generate a new processor.

Details regarding the hardware composer 214 are described more fully in the above referenced commonly assigned related application entitled A METHODOLOGY TO GENERATE EFFICIENT ARCHITECTURES FOR DEEP LEARNING to be filed on Jul. 14, 2023, which also claims priority to U.S. Provisional Patent Application Ser. No. 63/389,673, filed Jul. 15, 2022, the disclosure of which is incorporated herein by reference.

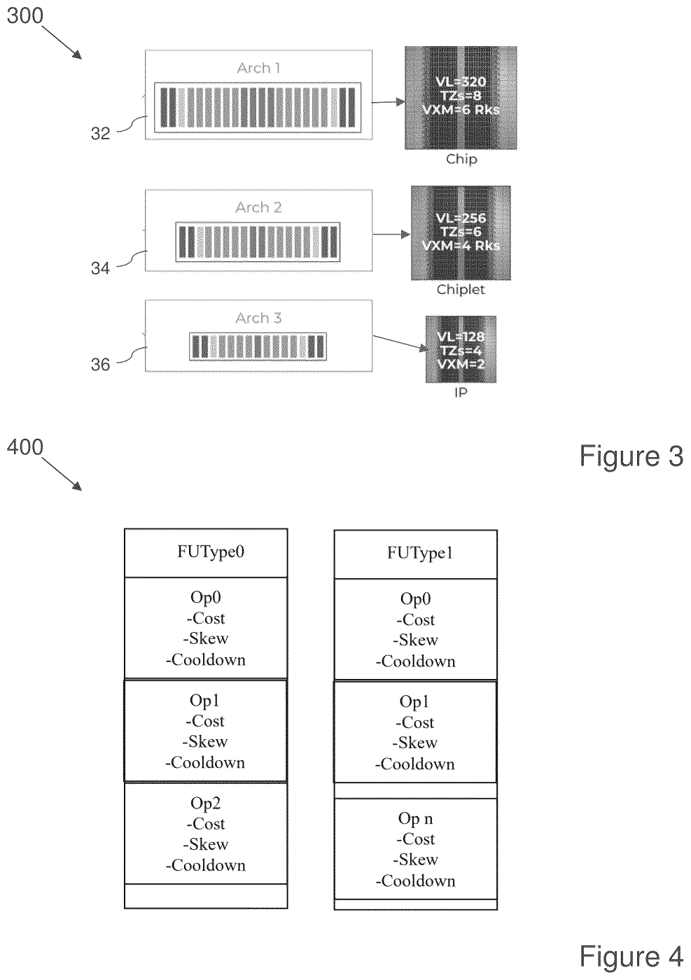

The selection process may be as simple as selecting from a pre-existing library of available processor architectures. FIG. 3 depicts a library 300, which is associated with chip model generator 216, that comprises three different processor architectures 32, 34 and 36. The first architecture 32, Arch 1, is illustrated as having two slices of functional units that perform multiplies and multiply accumulate arithmetic (denoted elsewhere herein as MXM functional units). Two slices of multipliers on either side of the device are represented by the four gray bars, two on each side. In the central region of the illustrated architecture, there are four slices of logic units (denoted elsewhere herein as either ALU or VXM functional units) represented by the four contiguous dark red bars on Arch 1. On either side of the ALU slices are six orange slices of memory (MEM functional units) as represented by the orange bars. Between the MEM slices and the gray MXM slice is a single switch matrix represented as a single gold bar (denoted herein as SXM functional units).

In library 300, the three processor architectures have different structures of each type of functional units (MXM, SXM, MEM or VXM). For example, Arch 1 has 12 slices of MEM which implies significant storage capacity for storage of weights and activations. Thus Arch 1 may be more suitable for models having a high number of weights (e.g., 65 billion) compared to Arch 3, by way of comparison which has eight slices of MEM. It should also be noted that the height of each slice, as illustrated in Arch 1, is depicted as being taller or longer which means that more functional units are provided in each slice. Thus, Arch 1 is optimally configured for a vector length of, by way of example, 320 elements, whereas Arch 2 is optimally configured for a vector length of, by way of example, 256 elements and Arch 3 is optimally configured for a vector length of, by way of example, 128 elements. Arch 3 may be suitable for a smaller model where ‘smaller’ is a relative term compared to the ‘larger’ models that may require the additional functional units in order to timely execute the model.

If none of the pre-existing architectures in library 300 enable execution of the model in view of the performance constraints, then the performance calculator may seek to optimize the configuration of the functional units, such out number of units, vector widths, capacity, etc., using a stochastic search algorithm such as simulated annealing to adjust architectures.

Simulated annealing is a probabilistic technique for approximating the global optimum of a given function. Specifically, it is a metaheuristic to approximate global optimization in a large search space for an optimization problem. In one embodiment, a simulated annealing can be used to decide which type of functional unit should be increased in size or quantity. For example, performance calculator 212 may seek to increase memory capacity and vector height in view of any power constraints. If the model executes correctly, performance calculator 212 may seek to reduce vector length and also reduce one or more of the functional slices to reduce power or cost. For each iteration, a request can be sent to hardware composer 214 to build a new architecture. This process can also be parallelized to explore more variations in parallel. Simulated annealing is just one example of a heuristic search and in other ECINs, Software Composer could use genetic algorithms or other stochastic search processes.

In one embodiment, different clock values, voltage levels, memory capacity, including external memory such as DDR5 vs DDR4, different chip-to-chip (C2C) links and bandwidth, die-2-die (D2D) or PCie versions, can be selected in an iteration and then changed in the next iteration to different selections. This exploratory process is preferably automatic without human intervention.

When hardware composer 214 finalizes a new architecture in response to the performance calculator 212 request, the new architecture is delivered to mapper 208. Mapper 208 uses the pre-existing IR instructions developed for the previous iteration and simply maps those instructions to the new processor architecture and then invokes scheduler 210 to schedule the instructions on the new iteration of the architecture.

When hardware composer 214 delivers the new architecture to mapper 208, the delivery includes a general chip model (GMC) that describes the functional structure of each slice and the location of each slice on the chip together with a FU template (FUnit) for each slice. The FUnit may be composed as one of the following: a MXM FU for multiply accumulate operations and dot-products, a MEM FU for memory structure for storing bytes of data, a VXM for performing various boolean and arithmetic operations and casting of different data types such as fp32 to INTEGER, a SXM for switching and permutation operations. Other FUs may be designed should there be a need to implement a model. In the preferred embodiment, a deterministic architecture allows exact performance to be known at compile time—no hardware (e.g., there is no need to receive first silicon from the foundry) and no need to develop a cycle accurate simulator to perform simulations of the processor's revised architecture.

The GCM defines the fundamental structure of the chip (e.g., processor) architecture. As long as a chip architecture adheres to this fundamental structure, the compiler is made fully aware of both data and instruction flow as well as resource utilization. This fundamental structure sets the bounds of what the compiler supports because it represents all of the architecture information needed by the compiler. Specifically, the fundamental structure provides connectivity, timing, relative positions, and number of functional units to the compiler in a time-efficient manner.

FIG. 4 depicts, in part, the foundational structure of the Operation Information (or Op Info) Tables. Each FUnit has a corresponding OP Info Table that defines the Instruction Set for the FUnit. The Op Info Tables also define instruction specific timing information for each instruction in the Instruction Set. Additional information may be included in the Op Info Tables such as, by way of example, cost to execute the instruction. For example, a multiplier may have a cost of 8 clock cycles before an output would be available on the Out Port of the FUnit.

The GCM may further comprise a plurality of interface technologies such as PCIe circuit blocks to provide connectivity to a host processor. While PCIe is not deterministic when connected to a non-deterministic host, the blocks enable weights and activations to be moved from the host to the TSP.

The GCM may further comprise a plurality of chip-to-chip or die-to-die connectors that allow multiple chips to exchange data at a much higher rate than is possible across the PCIe interface. Typically, such C2C or D2D connectors are positioned to couple superlanes on one chip to another chip. C2C and D2D connectors are direct point-to-point IO links between chips or dies, which are known in the art and are not further discussed herein. Hardware composer 404 is able to populate the periphery of a chip with such connectors to enable efficient data transfer between chips.

If the last iteration of the processor when combined with the current version of the model, library 300 is updated to include the new architecture for the processor together with metadata that describes the model name together with embedding, training data or other documentation that will assist the user in implementing the model to achieve an intended result.

In some instances, however, the model is sufficiently complex and the performance constraints so restrictive that there exists no combination of model and processor that will result in satisfactory performance. In such instances, performance calculator 212 issues a request to system input module 202 to select a new model. This request may be passed by system input module 202 to software composer 204 with the directive to select an alternative model. The selection process may be as simple as to provide a link to a repository having an existing library of trained models. Examples of such repositories include Hugging Face (available at https://huggingface.co/models) or GitHub where many AI practitioners and researchers utilize GitHub to share their AI models, code, and related resources. It is possible to find numerous AI models and related projects hosted on GitHub repositories at the GitHub website (github.com).

With a new AI model selected, software composer 204 invokes the front end of the compiler 206 and mapper 208 to generate processor specific architectures to be compared to the processor library as previously described.

However, since machine learning is a new product field that has only recently seen commercially viable models released for commercial use, it is expected that many models may be complex and without any viable alternative models. In such instances, software composer 204 is adapted to provide a user interface to use automated machine learning (AutoML) tools to automate the tasks of applying machine learning to real-world problems. One such tool is available from Google, Inc., at https://cloud.google.com/autom1/. Similar tools are available from IBM at https://www.ibm.com/products/watson-studio/autoai?utm content=SRCWW&p1=Search&p4=43700075141706602&p5=e&&msclkid=6bfe70294ac61664c7b114867316835c&gclid=6bfe70294ac61664c7b114867316835c&gclsrc=3p.ds

These and similar tools can be used to edit or revise an existing PyTorch, TensorFlow or Keras machine learning model to create a new model that eliminates the portions of the prior model that created roadblocks to implementation. Such tools also enable a user to retrain the revised model as well as to provide a set of input data points to be used for training. The raw data may not be in a form that all algorithms can be applied to. To make the data amenable for machine learning, an expert user may have to apply appropriate data pre-processing, feature engineering, feature extraction, and feature selection methods. After these steps, users then perform algorithm selection and hyperparameter optimization to maximize the predictive performance of the model as well as the architecture of the neural network. Each of these steps may be challenging and AutoML aims to simplify these steps for non-experts, and to make it easier to use machine learning techniques correctly and effectively. AutoML plays an important role within the broader approach of automating data science, which also includes challenging tasks such as data engineering, data exploration and model interpretation.

Once the model is adjusted to hit the required accuracy and performance constraints, software composer 204 passes the new model to the compiler front-end 206 to execute. If the performance calculator 212 calculates that the results meet or exceed the input constraints, the model is delivered as compiled code for execution on the selected processor. The compiled code may be subsequently executed by the processor (having the optimal architecture) located, by way of example, in a data center or locally if the code is to be executed by a mobile computing device such as a cell phone or an autonomous vehicle.

In one embodiment, once the user found an optimum architecture, it can be implemented at least partially on a FPGA. As will be appreciated, FPGA CAD tools can be used to compile HDL down to a bitstream and allow for configuring the chip (LUTs DSPs, BRAM, routing). Performance metrics of the bitstream can be statically determined (resource utilization, fmax). Typically, compilation requires a detailed, low-level chip model. Verilog-to-Routing (VTR) is an open-source FPGA CAD tool used for FPGA architecture exploration. VTR can compile for any FPGA architecture that fits within its chip model framework.

In one embodiment, once the system has reached an optimum architecture, the processor architecture can be implemented or instantiated as a new ASIC chip design manufactured by a commercial semiconductor foundry.

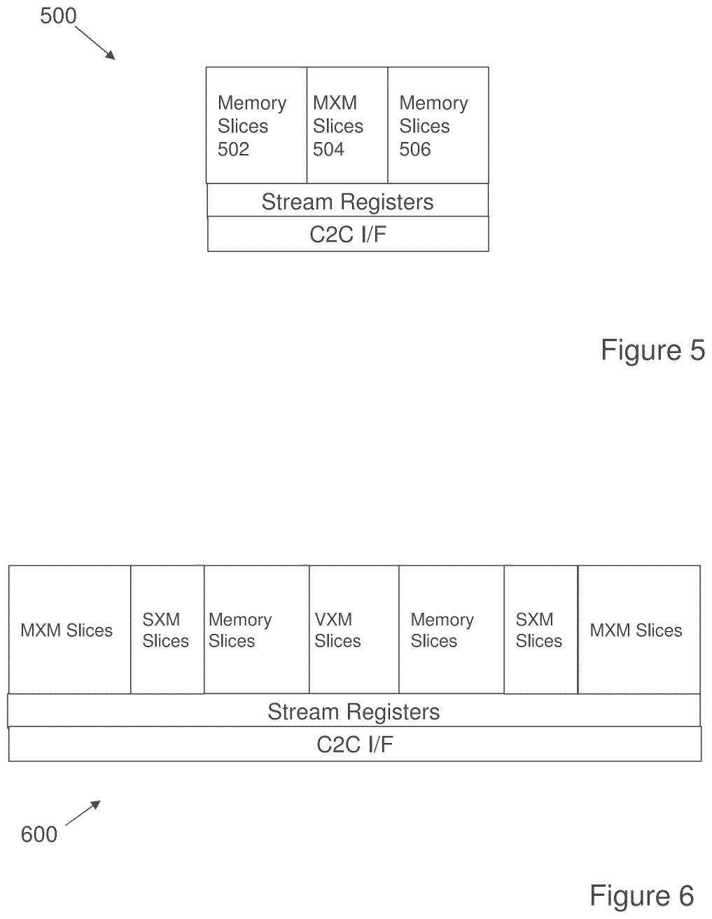

Refer now to FIGS. 5 and 6 where two processor architectures are depicted. In FIG. 5, a first processor architecture is depicted having memory slices 502 and 506 surrounding an array of multiplier accumulators for implementing matrix multiplication arithmetic operations. In this embodiment, slices 502-506 provide massive compute capacity and are ideally suited for instantiation on a chiplet device. The functional units comprise each slice coupled by stream registers to other functional units and by C2C interfaces to other processors or to other devices like sensor chips or external memory chips. An example of another processor is depicted in FIG. 6 having a significantly different architecture compared to the processor depicted in FIG. 5. More specifically, the processor architecture in FIG. 6 represents a commercially available tensor streaming processor available from Groq, Inc. of Mountain View, California while the processor architecture in FIG. 5 represents a processor that is composed by hardware composer 214.

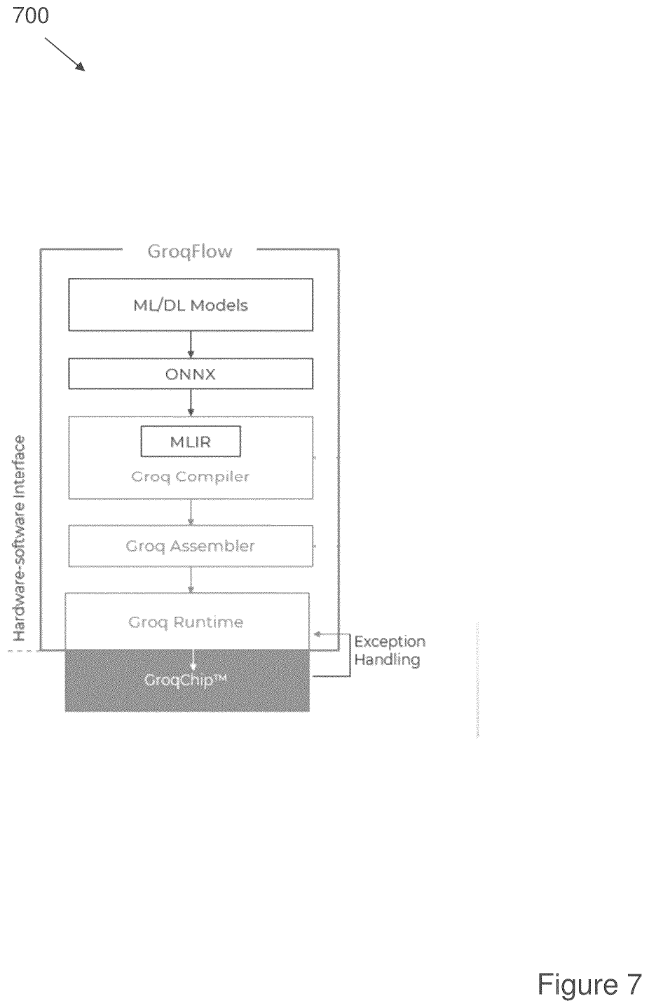

By directly connecting each processor to the other using the C2C interface, the compiler described below in FIG. 7 is able to access the combined available resources to efficiently scale a model to perform mathematical operations on models having hundreds to millions of vectors, and can remove functional units (and hence reduce the power associated with those removed units) that would otherwise not be efficiently utilized for a particular model. Thus, the hardware composer 214 (FIG. 2) is not restricted in composing a processor architecture but is free to adopt a wide variety of processor architectures.

FIG. 7 illustrates one example of a compiler system 700 capable of use in the system depicted in FIG. 2. In one embodiment, high level models from TensorFlow, PyTorch, or others can be passed through model converters into ONNX or other formats built to represent machine learning models. Advantageously, ONNX defines a common set of operators—the building blocks of machine learning and deep learning models—and a common file format. This data is provided to MLIR (Multi-Level Intermediate Representation) and a parallelizing compiler system that can provide front-end optimizations, perform layout markings and optimizations such as taking multidimensional tensors and mapping them down to a physical address space that is a one dimensional address space and has no hierarchy. In addition, re-writes are supported, taking higher level neural network graphs and decomposing them into semantically equivalent graphs with nodes in the graph that represent operations that are more similar to what exist in the TSP ISA.

Compiler mediated deterministic processing is enabled by hardware control at a chip, card, computer, rack, or network level. This can include vector-level scheduling, translation into assembly, and implementation for runtime control of the TSP that together enable software to schedule deterministic processing of the model or other data processing task. The chip can have integrated software control units at strategic points to optimize data movement and processing and be organized in a way consistent with typical data flow found in machine learning models. The TSP guarantees determinism by eliminating all reactive elements in the hardware, for example, arbiters and caches. The instruction ordering is entirely software controlled and the underlying hardware cannot reorder these events—they must complete in a fixed amount of time.

As shown, the compiler translates the input PyTorch, TensorFlow or other AI model (after going through ONNX optimization) and re-write the ONNX code (that is designed for CPU or for GPU computational models) to make it compilable with a TSP computational architecture. The model when fed into the compiler generates a directed acyclic graph (DAG) of the model, rewrites the operators in the model into special purpose hardware instructions, schedules the hardware instructions down to each clock cycle, optimizes the instructions within desired runtime constraints, and assembles the scheduled instructions with constraint metadata in a binary that can be delivered to the TSP that executes the instructions within the binary. The processor executes the instructions to process data inputs for the machine learning model and generates output corresponding to the output of the predictive model. Furthermore, the execution of the model in the processor results in performance that conforms to the stated constraints indicated in the constraint metadata. These constraints may include time to run, power used, memory used, heat generated, etc. This allows a designer or other user to include the processor with compiled binary as a component in a larger device knowing that the processing of the machine model will always be within the stated constraints and not exceed them. As an additional advantage, simulations or other performance estimating software is not needed to evaluate (module 130) performance but can be directly determined by compiler system 200.

In one embodiment a network of TSP processors can be connected via Chip-to-Chip (C2C) modules to execute a single model. The processors logically behave as if all chips share a common clock and are connected via time multiplexed wires. TSP chips connected via C2C do not need to share a clock; reasonable alignment of the frequency of the clocks (measured in PPM) will suffice. The receive buffers in the communications modules must be large enough so that the expected PPMs of clocks don't require a realignment more than once per millisecond

C2C modules either provide sufficient Forward Error Correction for data transfer between chips to minimize unrecoverable errors or provide software with a mechanism to add additional redundancy so that errors are minimized. Each C2C can be an independent link, e.g., each link may be the only connection to another device or may be one of multiple connections to another device.

Embodiments of multi-chip systems can be implemented in a variety of topologies for flexible packaging and deployment in rack-scale and cluster scale systems. Communication occurs in a pair-wise manner between a sender port and a receiver port (e.g., single point-to-point communication with no arbitration or dynamic routing).

Data and Information. While ‘data’ and ‘information’ often are used interchangeably (e.g., ‘data processing’ and ‘information processing’), the term ‘datum’ (plural ‘data’) typically signifies a representation of the value of a fact (e.g., the measurement of a physical quantity such as the current in a wire, or the price of gold), or the answer to a question (e.g., “yes” or “no”), while the term ‘information’ typically signifies a set of data with structure (often signified by ‘data structure’). A data structure is used in commerce to transform an electronic device for use as a specific machine as an article of manufacture. Data and information are physical objects, for example binary data (a ‘bit’, usually signified with ‘0’ and ‘1’) enabled with two levels of voltage in a digital circuit or electronic component. For example, data can be enabled as an electrical, magnetic, optical or acoustical signal or state; a quantum state such as a particle spin that enables a ‘qubit’; or a physical state of an atom or molecule. All such data and information, when enabled, are stored, accessed, transferred, combined, compared, or otherwise acted upon, actions that require and dissipate energy.

### DETAILED DESCRIPTION—TECHNOLOGY SUPPORT FROM DATA/INSTRUCTIONS TO PROCESSORS/PROGRAMS

As used herein, the term ‘process’ signifies an artificial finite ordered set of physical actions (‘action’ also signified by ‘operation’ or ‘step’) to produce at least one result. Some types of actions include transformation and transportation. An action is a technical application of one or more natural laws of science or artificial laws of technology. An action often changes the physical state of a machine, of structures of data and information, or of a composition of matter. Two or more actions can occur at about the same time, or one action can occur before or after another action, if the process produces the same result. A description of the physical actions and/or transformations that comprise a process are often signified with a set of gerund phrases (or their semantic equivalents) that are typically preceded with the signifier ‘the steps of’ (e.g., “a process comprising the steps of measuring, transforming, partitioning and then distributing . . . ”). The signifiers ‘algorithm’, ‘method’, ‘procedure’, ‘(sub)routine’, ‘protocol’, ‘recipe’, and ‘technique’ often are used interchangeably with ‘process’, and 35 U.S.C. 100 defines a “method” as one type of process that is, by statutory law, always patentable under 35 U.S.C. 101. As used herein, the term ‘thread’ signifies a subset of an entire process. A process can be partitioned into multiple threads that can be used at or about at the same time.

As used herein, the term ‘rule’ signifies a process with at least one logical test (signified, e.g., by ‘IF test IS TRUE THEN DO process’). As used herein, a ‘grammar’ is a set of rules for determining the structure of information. Many forms of knowledge, learning, skills and styles are authored, structured, and enabled—objectively—as processes and/or rules—e.g., knowledge and learning as functions in knowledge programming languages.

As used herein, the term ‘component’ (also signified by ‘part’, and typically signified by ‘element’ when described in a patent text or diagram) signifies a physical object that is used to enable a process in combination with other components. For example, electronic components are used in processes that affect the physical state of one or more electromagnetic or quantum particles/waves (e.g., electrons, photons) or quasiparticles (e.g., electron holes, phonons, magnetic domains) and their associated fields or signals. Electronic components have at least two connection points which are attached to conductive components, typically a conductive wire or line, or an optical fiber, with one conductive component end attached to the component and the other end attached to another component, typically as part of a circuit with current or photon flows. There are at least three types of electrical components: passive, active and electromechanical. Passive electronic components typically do not introduce energy into a circuit—such components include resistors, memristors, capacitors, magnetic inductors, crystals, Josephson junctions, transducers, sensors, antennas, waveguides, etc. Active electronic components require a source of energy and can inject energy into a circuit—such components include semiconductors (e.g., diodes, transistors, optoelectronic devices), vacuum tubes, batteries, power supplies, displays (e.g., LEDs, LCDs, lamps, CRTs, plasma displays). Electromechanical components affect current flow using mechanical forces and structures—such components include switches, relays, protection devices (e.g., fuses, circuit breakers), heat sinks, fans, cables, wires, terminals, connectors and printed circuit boards.

One of the most important components as goods in commerce is the integrated circuit, and its res of abstractions. As used herein, the term ‘integrated circuit’ signifies a set of connected electronic components on a small substrate (thus the use of the signifier ‘chip’) of semiconductor material, such as silicon or gallium arsenide, with components fabricated on one or more layers. Other signifiers for ‘integrated circuit’ include ‘monolithic integrated circuit’, ‘IC’, ‘chip’, ‘microchip’ and ‘System on Chip’ (‘SoC’). Examples of types of integrated circuits include gate/logic arrays, processors, memories, interface chips, power controllers, and operational amplifiers. The term ‘cell’ as used in electronic circuit design signifies a specification of one or more components, for example, a set of transistors that are connected to function as a logic gate. Cells are usually stored in a database, to be accessed by circuit designers and design processes.

As used herein, the term ‘module’ signifies a tangible structure for acting on data and information. For example, the term ‘module’ can signify a process that transforms data and information, for example, a process comprising a computer program (defined below). The term ‘module’ also can signify one or more interconnected electronic components, such as digital logic devices. A process comprising a module, if specified in a programming language (defined below), such as System C or Verilog, also can be transformed into a specification for a structure of electronic components that transform data and information that produce the same result as the process. This last sentence follows from a modified Church-Turing thesis, which is simply expressed as “Whatever can be transformed by a (patentable) process and a processor, can be transformed by a (patentable) equivalent set of modules.”, as opposed to the doublethink of deleting only one of the “(patentable)”.

A module is permanently structured (e.g., circuits with unalterable connections), temporarily structured (e.g., circuits or processes that are alterable with sets of data), or a combination of the two forms of structuring. Permanently structured modules can be manufactured, for example, using Application Specific Integrated Circuits (‘ASICs’) such as Arithmetic Logic Units (‘ALUs’), Programmable Logic Arrays (‘PLAs’), or Read Only Memories (‘ROMs’), all of which are typically structured during manufacturing. For example, a permanently structured module can comprise an integrated circuit. Temporarily structured modules can be manufactured, for example, using Field Programmable Gate Arrays (FPGAs), Random Access Memories (RAMs) or microprocessors. For example, data and information is transformed using data as an address in RAM or ROM memory that stores output data and information. One can embed temporarily structured modules in permanently structured modules (for example, a FPGA embedded into an ASIC).

Modules that are temporarily structured can be structured during multiple time periods. For example, a processor comprising one or more modules has its modules first structured by a manufacturer at a factory and then further structured by a user when used in commerce. The processor can comprise a set of one or more modules during a first time period, and then be restructured to comprise a different set of one or modules during a second time period. The decision to manufacture or implement a module in a permanently structured form, in a temporarily structured form, or in a combination of the two forms, depends on issues of commerce such as cost, time considerations, resource constraints, tariffs, maintenance needs, national intellectual property laws, and/or specific design goals. How a module is used, its function, can be mostly independent of the physical form in which it is manufactured or enabled.

As used herein, the term ‘processor’ signifies a tangible data and information processing machine for use in commerce that physically transforms, transfers, and/or transmits data and information, using at least one process. A processor consists of one or more modules, e.g., a central processing unit (‘CPU’) module; an input/output (‘I/O’) module, a memory control module, a network control module, and/or other modules. The term ‘processor’ can also signify one or more processors, or one or more processors with multiple computational cores/CPUs, specialized processors (for example, graphics processors or signal processors), and their combinations. Where two or more processors interact, one or more of the processors can be remotely located relative to the position of the other processors. Where the term ‘processor’ is used in another context, such as a ‘chemical processor’, it will be signified and defined in that context.

The processor can comprise, for example, digital logic circuitry (for example, a binary logic gate), and/or analog circuitry (for example, an operational amplifier). The processor also can use optical signal processing, DNA transformations, quantum operations, microfluidic logic processing, or a combination of technologies, such as an optoelectronic processor. For data and information structured with binary data, any processor that can transform data and information using the AND, OR and NOT logical operations (and their derivatives, such as the NAND, NOR, and XOR operations) also can transform data and information using any function of Boolean logic. A processor such as an analog processor, such as an artificial neural network, also can transform data and information.

The one or more processors also can use a process in a ‘cloud computing’ or ‘timesharing’ environment, where time and resources of multiple remote computers are shared by multiple users or processors communicating with the computers. For example, a group of processors can use at least one process available at a distributed or remote system, these processors using a communications network (e.g., the Internet, or an Ethernet) and using one or more specified network interfaces (‘interface’ defined below) (e.g., an application program interface (‘API’) that signifies functions and data structures to communicate with the remote process).

As used herein, the term ‘computer’ and ‘computer system’ (further defined below) includes at least one processor that, for example, performs operations on data and information such as (but not limited to) the Boolean logical operations using electronic gates that can comprise transistors, with the addition of memory (for example, memory structured with flip-flops using the NOT-AND or NOT-OR operation). A computer can comprise a simple structure, for example, comprising an I/O module, a CPU module, and a memory that performs, for example, the process of inputting a signal, transforming the signal, and outputting the signal with no human intervention.

As used herein, the term ‘programming language’ signifies a structured grammar for specifying sets of operations and data for use by modules, processors and computers. Programming languages include assembler instructions, instruction-set-architecture instructions, machine instructions, machine dependent instructions, microcode, firmware instructions, state-setting data, or either source code or object code written in any combination of one or more higher level languages, for example, the C programming language and similar general programming languages (such as Fortran, Basic, Javascript, PHP, Python, C++), knowledge programming languages (such as Lisp, Smalltalk, Prolog, or CycL), electronic structure programming languages (such as VHDL, Verilog, SPICE or SystemC), text programming languages (such as SGML, HTML, or XML), or audiovisual programming languages (such as SVG, MathML, X3D/VRML, or MIDI), and any future equivalent programming languages. As used herein, the term ‘source code’ signifies a set of instructions and data specified in text form using a programming language.

As used herein, the term ‘program’ (also referred to as an ‘application program’) signifies one or more processes and data structures that structure a module, processor or computer to be used as a specific machine. One use of a program is to structure one or more computers, for example, standalone, client or server computers, or one or more modules, or systems of one or more such computers or modules. As used herein, the term ‘computer application’ signifies a program that enables a specific use, for example, to enable text processing operations, or to encrypt a set of data. As used herein, the term ‘firmware’ signifies a type of program that typically structures a processor or a computer, where the firmware is smaller in size than a typical application program and is typically not very accessible to or modifiable by the user of a computer. Computer programs and firmware are often specified using source code written in a programming language, such as C. Modules, circuits, processors, programs and computers can be specified at multiple levels of abstraction, for example, using the SystemC programming language, and have value as products in commerce as taxable goods.

A program can be transferred into one or more memories of the computer or computer system from a data and information device or storage system. A computer system typically has a device for reading storage media that is used to transfer the program, and/or has an interface device that receives the program over a network.

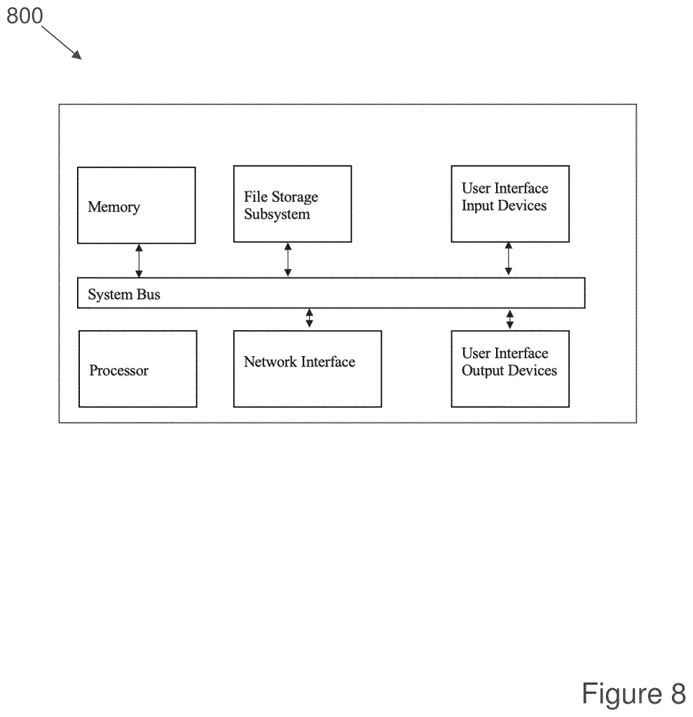

As will be understood, a computer system 800 such as illustrated with respect to FIG. 8 is suitable for supporting embodiments described in this disclosure and can include at least one computer (CPU and/or GPU) which communicates with peripheral devices via bus subsystem. Typically, as depicted in FIG. 8, the computer includes a processor (e.g., a microprocessor, graphics processing unit, or digital signal processor), or its electronic processing equivalents, such as an Application Specific Integrated Circuit (‘ASIC’) or Field Programmable Gate Array (‘FPGA’). Typically, peripheral devices include a storage subsystem, comprising a memory subsystem and a file storage subsystem, user interface input devices, user interface output devices, and/or a network interface subsystem. The input and output devices enable direct and remote user interaction with the computer system. The computer system enables significant post-process activity using at least one output device and/or the network interface subsystem.

The computer system can be structured as a server, a client, a workstation, a mainframe, a personal computer (PC), a tablet PC, a set-top box (STB), a personal digital assistant (PDA), a cellular telephone, a smartphone, a web appliance, a rack-mounted ‘blade’, a kiosk, a television, a game station, a network router, switch or bridge, or any data processing machine with instructions that specify actions to be taken by that machine. The term ‘server’, as used herein, refers to a computer or processor that typically performs processes for, and sends data and information to, another computer or processor.

A computer system typically is structured, in part, with at least one operating system program. The computer system typically includes a Basic Input/Output System (BIOS) and processor firmware. The operating system, BIOS and firmware are used by the processor to structure and control any subsystems and interfaces connected to the processor.

Any embodiment is limited neither to an electronic digital logic computer structured with programs nor to an electronically programmable device. For example, the claimed inventions can use an optical computer, a quantum computer, an analog computer, or the like. Further, where only a single computer system or a single machine is signified, the use of a singular form of such terms also can signify any structure of computer systems or machines that individually or jointly use processes. Due to the ever-changing nature of computers and networks, the description of a computer system is intended only as an example.

Network interface subsystem provides an interface to outside networks, including an interface to a communication network, and is coupled via communication network to corresponding interface devices in other computer systems or machines. Communication networks can comprise many interconnected computer systems, machines and physical communication connections (signified by ‘links’). These communication links can be wireline links, optical links, wireless links (e.g., using the WiFi or Bluetooth protocols), or any other physical devices for communication of information. Communication network 18 can be any suitable computer network, for example a wide area network such as the Internet, and/or a local-to-wide area network such as Ethernet. The communication network is wired and/or wireless, and many communication networks use encryption and decryption processes, such as is available with a virtual private network. The communication network uses one or more communications interfaces, which receive data from, and transmit data to, other systems. Embodiments of communications interfaces typically include an Ethernet card, a modem (e.g., telephone, satellite, cable, or ISDN), (asynchronous) digital subscriber line (DSL) unit, Firewire interface, USB interface, and the like. Communication algorithms (‘protocols’) can be specified using one or communication languages, such as HTTP, TCP/IP, RTP/RTSP, IPX and/or UDP.

User interface input devices can include an alphanumeric keyboard, a keypad, pointing devices such as a mouse, trackball, toggle switch, touchpad, stylus, a graphics tablet, an optical scanner such as a bar code reader, touchscreen electronics for a display device, audio input devices such as voice recognition systems or microphones, eye-gaze recognition, brainwave pattern recognition, optical character recognition systems, and other types of input devices. Such devices are connected by wire or wirelessly to a computer system. Typically, the term ‘input device’ signifies all possible types of devices and processes to transfer data and information into a computer system or onto a communication network. User interface input devices typically enable a user to select objects, icons, text and the like that appear on some types of user interface output devices, for example, a display subsystem.

User interface output devices can include a display subsystem, a printer, a fax machine, or a non-visual communication device such as audio and haptic devices. The display subsystem can include a cathode ray tube (CRT), a flat-panel device such as a liquid crystal display (LCD), an image projection device, or some other device for creating visible stimuli such as a virtual reality system. The display subsystem also can provide non-visual stimuli such as via audio output, aroma generation, or tactile/haptic output (e.g., vibrations and forces) devices. Typically, the term ‘output device’ signifies all possible types of devices and processes to transfer data and information out of a computer system to the user or to another machine or computer system. Such devices are connected by wire or wirelessly to a computer system. Note: some devices transfer data and information both into and out of the computer, for example, haptic devices that generate vibrations and forces on the hand of a user while also incorporating sensors to measure the location and movement of the hand. Technical applications of the sciences of ergonomics and semiotics are used to improve the efficiency of user interactions with any processes and computers disclosed herein, such as any interactions with regards to the design and manufacture of circuits that use any of the above input or output devices.

The memory subsystem typically includes a number of memories including a main random-access memory (‘RAM’) (or other volatile storage device) for storage of instructions and data during program execution and a read only memory (‘ROM’) in which fixed instructions are stored. File storage subsystem provides persistent storage for program and data files, and can include a hard disk drive, a floppy disk drive along with associated removable media, a CD-ROM drive, an optical drive, a flash memory such as a USB drive, or removable media cartridges. If the computer system includes an input device that performs optical character recognition, then text and symbols printed on a physical object (such as paper) can be used as a device for storage of program and data files. The databases and modules used by some embodiments can be stored by file storage subsystems.

The bus subsystem provides a device for transmitting data and information between the various components and subsystems of the computer system. Although the bus subsystem is depicted as a single bus, alternative embodiments of the bus subsystem can use multiple buses. For example, a main memory using RAM can communicate directly with file storage systems using Direct Memory Access (‘DMA’) systems.

The memory can include a non-transitory, processor readable data and information storage medium associated with file storage subsystem, and/or with network interface subsystem, and can include a data structure specifying a circuit design. The memory can be a hard disk, a floppy disk, a CD-ROM, an optical medium, removable media cartridge, or any other medium that stores computer readable data in a volatile or non-volatile form, such as text and symbols on a physical object (such as paper) that can be processed by an optical character recognition system. A program transferred into and out of a processor from such a memory can be transformed into a physical signal that is propagated through a medium (such as a network, connector, wire, or circuit trace as an electrical pulse); or through a medium such as space or an atmosphere as an acoustic signal, or as electromagnetic radiation with wavelengths in the electromagnetic spectrum longer than infrared light.

### DETAILED DESCRIPTION—CONCLUSION

The Detailed Description signifies in isolation the individual features, structures, functions, or characteristics described herein and any combination of two or more such features, structures, functions or characteristics, to the extent that such features, structures, functions or characteristics or combinations thereof are enabled by the Detailed Description as a whole in light of the knowledge and understanding of a skilled person, irrespective of whether such features, structures, functions or characteristics, or combinations thereof, solve any problems disclosed herein, and without limitation to the scope of the Claims herein. When an embodiment comprises a particular feature, structure, function or characteristic, it is within the knowledge and understanding of a skilled person to use such feature, structure, function, or characteristic in connection with another embodiment whether or not explicitly described, for example, as a substitute for another feature, structure, function or characteristic.

In view of the Detailed Description, a skilled person will understand that many variations of any embodiment can be enabled, such as function and structure of elements, described herein while being as useful as the embodiment. One or more elements of an embodiment can be substituted for one or more elements in another embodiment, as will be understood by a skilled person. Writings about any embodiment signify its use in commerce, thereby enabling other skilled people to similarly use this embodiment in commerce.

This Detailed Description is written to provide knowledge and understanding. It is neither exhaustive nor limiting of the precise structures described but is to be accorded the widest scope consistent with the disclosed principles and features. Without limitation, any and all equivalents described, signified or Incorporated By Reference (or explicitly incorporated) in this patent application are specifically incorporated into the Detailed Description. In addition, any and all variations described, signified or incorporated with respect to any one embodiment also can be included with any other embodiment. Any such variations include both currently known variations as well as future variations, for example any element used for enablement includes a future equivalent element that provides the same function, regardless of the structure of the future equivalent element.

It is intended that the domain of the set of claimed inventions and their embodiments be defined and judged by the following Claims and their equivalents. The Detailed Description includes the following Claims, with each Claim standing on its own as a separate claimed invention. Any embodiment can have more structure and features than are explicitly specified in the Claims.

What is claimed is:

1. A system for developing an AI model and processor, comprising:
a hardware composer arranged to provide a processor architecture representation to a mapper module;
a software composer arranged to take the AI model and pass it to a compiler for conversion into a device agnostic intermediate representation module that can be further mapped by a mapper module onto the processor architecture representation; and
a performance calculator arranged to receive results derived from the software composer and the hardware composer and model performance of the AI model on the processor architecture, with performance results being provided to the software composer and the hardware composer to permit respective adjustment of the AI model and the processor specific architecture.

2. The system of claim 1, wherein the processor architecture representation provided to the mapper module further comprises a general chip model (GMC) that describes functional structure and location of processor slices, together with a functional unit (FU) template for each slice.

3. The system of claim 1, further comprising a system input module connected between the performance calculator and the software composer to provide model selection and performance constraints to the performance calculator.

4. The system of claim 1, wherein the compiler further comprises a scheduler module connected between the mapper module and the performance calculator to schedule operand processing based on the GMC description.

5. The system of claim 1, wherein at least one of AI model and processor architecture is selected from an existing library.

6. The system of claim 1, wherein the processor architecture is selected using either genetic algorithms or stochastic search techniques.

7. The system of claim 1, wherein software composer invokes AutoML to change the AI model based on the performance results.

8. The system of claim 1, wherein the compiler compiles the selected AI model using multiple processor architectures.

9. A method for developing an AI model and processor for executing the AI model, comprising:
arranging a software composer to provide the AI model to a mapper module for mapping onto a processor specific architecture representation;
arranging a hardware composer to provide the processor architecture representation to the mapper module; and
arranging a performance calculator to receive results derived from the software composer and the hardware composer and model performance of the AI model on the processor system architecture, with performance results being provided to the software composer and the hardware composer to permit respective adjustment of the AI model and the processor specific architecture.

10. The method of claim 9, wherein the processor specific architecture representation provided to the mapper module further comprises a general chip model (GMC) that describes functional structure and location of processor slices, together with a functional unit (FU) template for each slice.

11. The method of claim 9, further comprising connecting a scheduler module between the mapper module and the performance calculator to schedule operand processing based on the GMC description.

12. The method of claim 9, further comprising connecting a system input module between the performance calculator and the software composer to provide model selection and performance constraints to the performance calculator.

13. The method of claim 9, wherein at least one of AI model and processor architecture is selected from an existing library.

14. The method of claim 9, wherein processor architecture is selected using simulated annealing techniques.

15. The method of claim 9, wherein the compiler compiles the AI model with multiple processor architectures until performance result targets are achieved or a new AI model is selected.

16. A method of improving performance of a processor system and associated software, comprising:
selecting a set of performance parameter targets for a processor architecture having a set of functional units and an AI model;
evaluating performance of the processor architecture and the AI model;
adjusting at least one of the functional units of the processor architecture to form a new processor architecture prior to iteratively evaluating the combination of the new processor architecture and the AI model; and
repeating the evaluating step and the adjustment step until the performance evaluation of the processor architecture and the AI model meets the set of performance parameter targets.

17. The method of claim 16, wherein selecting the performance parameters targets are at least one of consumed power, latency; throughput constraint; accuracy, die-area (costs) and thermal performance for the processor architecture.

18. The method of claim 16, wherein the processor architecture is deterministic.

19. The method of claim 16, wherein the processor architecture is a tensor streaming processor.

20. The method of claim 16, further comprising
arranging a software composer to take the AI model and pass it to a compiler for conversion into a device agnostic intermediate representation module that can be further mapped by a mapper module onto a processor specific architecture representation;
arranging a hardware composer to provide the processor specific architecture representation to the mapper module; and
arranging a performance calculator to receive results derived from the software composer and the hardware composer and model performance of the AI model on the processor architecture, with performance results being provided to the software composer and the hardware composer to permit respective adjustment of the AI model and the processor architecture.
